(19) United States
(12) Patent Application Publication
(10) Pub. No.: US 2003/0076983 A1
(43) Pub. Date: Apr. 24, 2003

(54) Personal food analyzer

(76) Inventor: Dale W. Cox, El Segundo, CA (US)

Correspondence Address: ALLEN A. DICKE, Jr., 224 Mall Way, Anaheim, CA, 92804, US

(21) Appl. No.: 09/774,889

(22) Filed: Feb. 1, 2001

Related U.S. Application Data
(60) Provisional application No. 60/209,623, filed on Jun. 6, 2000.

(51) Int. Cl. G06K 9/00; G06K 9/46; G06K 9/36

(52) U.S. Cl. 382/110; 382/203; 382/286

(57) ABSTRACT

Two separate white light illuminated images are acquired of a plate of food. The image data is processed, and the two images are compared to determine volume of particular food zones. In parallel to that, the food type in each zone is identified by a food recognition processor nd reference to a stored nutritional data bank. These two values are combined with the foods' nutritional value in the data bank to provide zone-by-zone nutrient content information. These can be individually displayed, and/or the total displayed so that the user knows the nutritional value of the food on his plate in terms of total calories, percent fat, percent protein, and percent carbohydrate. In addition, the approximate milligrams each of principal vitamin, mineral, fiber, enzyme and phytonutrient on the plate can be displayed sequentially. Provision is made to download data into a PDA or PC.

### CROSS-REFERENCE

This invention relies upon provisional patent application Ser. No. 60/209,623, filed Jun. 6, 2000, for priority.

### FIELD OF THE INVENTION

This application is directed to a personal food analyzer in the form of a hand-held device which captures one or more images of a plate of food to determine the nature, type and amount of the food. Internal reference to a data bank provides information as to the total calories, percent fat, protein, and carbohydrate; grams or milligrams of fiber, vitamins and minerals in the food. Thus, the person planning to consume the food can identify the principal characteristics of the food to be eaten and can view a totalized nutrition content over a period of time.

### BACKGROUND OF THE INVENTION

In affluent societies, there is more food available to each individual than is nutritionally necessary. In addition, many people are becoming very health conscious. Thus, the diner has a choice as to the nutritional quality, as well as the amount of food he eats. Some people, for example, must limit fats or cholesterol, while others may wish to increase anti-oxidants. Some diners prefer to limit the amount of calories ingested for reasons of that person's weight. He may wish to maintain his weight, lose weight, or on a few occasions, gain weight. Other diners might want to control glucose intake. It is, thus, helpful to such a consumer to know the caloric value of the food on his plate. At present, caloric value is calculated by individually weighing each food item on the plate and multiplying by an appropriate calorie/weight value. This process is not appropriate in a restaurant.

While such a process is accurate, it can only reasonably be accomplished in the kitchen because each food on the plate must be weighed separately. It would be very useful to have a hand-held device which could be held over a plate of food to determine the nutritional values of the food on the plate. This should be done without physical contact, so that the calculations can be accomplished quickly in both home and restaurant settings.

### SUMMARY OF THE INVENTION

In order to aid in the understanding of this invention, it can be stated in essentially summary form that it is directed to a small, hand-held personal food analyzer which takes one or more images of food on a plate and analyzes these images so that the nature and amount of the various foods on the plate are individually determined so that the type and amount of nutritional content can be calculated and provided to an output—usually a visual output.

It is, thus, a purpose and advantage of this invention to provide a personal food analyzer which is portable and which is preferably hand-held and pocket-sized so that the personal food analyzer can be conveniently carried along and utilized when the user is about to eat to advise him of the nutritional content of the plate of food before him.

It is another purpose and advantage of this invention to provide a personal food analyzer which takes an image, and preferably two images of the plate of food and which is provided with memory information and calculating capability using existing off-the-shelf software so that the food in the image can be identified and the volume of the contents in each food area established. Once food type and volume are determined, the nutritional values and totals are calculated from the permanent data base within the food analyzer.

It is another purpose and advantage to provide a personal food analyzer which can be carried with the user so that he may determine the nutritional content of a plate of food and compare that nutritional content with his own needs so that he can regulate nutritional intake in accordance with his dietary and health requirements.

Another purpose and advantage of the invention is to provide an alternate version, with a fixed, table top nutritional analyzer for use in restaurants producing a printed output of the nutritional data, which printed data would be delivered to customers who so request, along with the plate of food.

These and other purposes and advantages of this invention will become apparent from the study of the following portion of this specification, taken in conjunction with the accompanying drawings.

### BRIEF DESCRIPTION OF THE DRAWINGS

FIG. 1 is a perspective view showing the first preferred embodiment of this invention in association with an exemplary plate of food.

FIG. 2 is a perspective view of the food analyzer of FIG. 1.

FIG. 3 is a block diagram showing the equipment and process steps occurring within the personal food analyzer to calculate and display the nutritional information.

FIG. 4 is a side-elevational view of the second preferred embodiment of the personal food analyzer of this invention.

FIG. 5 is a bottom view thereof.

FIG. 6 is a right-hand view thereof.

FIG. 7 is a perspective view showing the second preferred embodiment of the personal food analyzer of this invention in association with a plate of food, showing it in full lines in a first position and showing it in phantom lines in a second position.

FIG. 8 is a block diagram showing the equipment and process steps by which the nutritional value of the plate is calculated and displayed.

### DESCRIPTION OF THE PREFERRED EMBODIMENTS

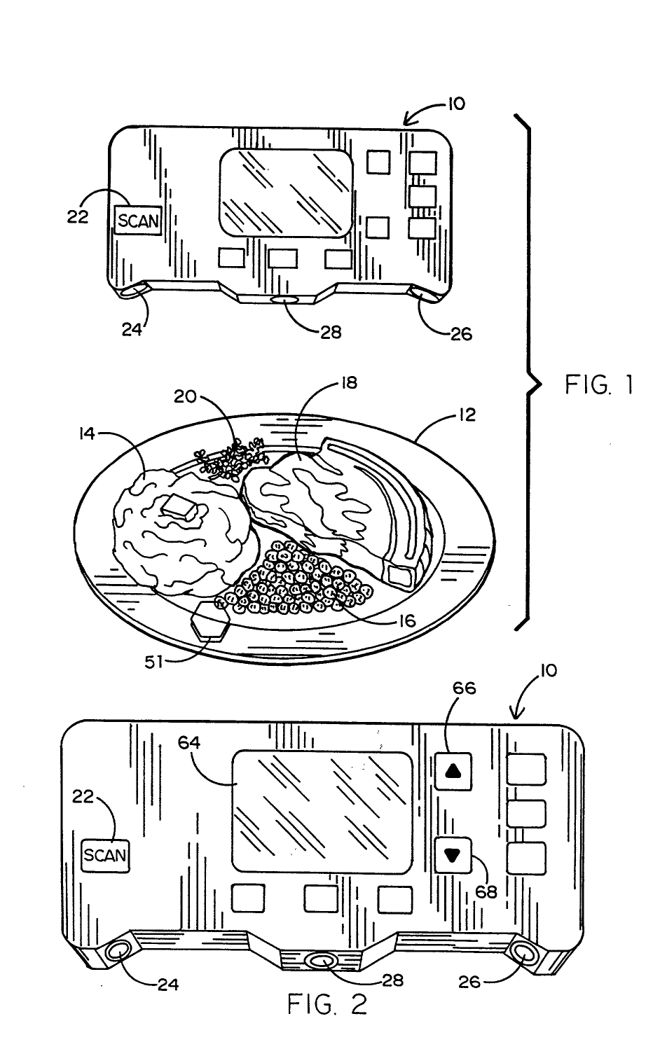

FIG. 1 shows the first preferred embodiment of the personal food analyzer 10 in association with a dinner plate 12. The dinner plate 12 is a standard restaurant dinner plate with three portions of food thereon. As a particular example, the food comprises mashed potatoes 14 with a pat of butter thereon, peas 16 and beefsteak 18. The plate also carries a sprig of parsley 20, which is often used as plate decoration and which is not usually eaten. When an analysis of the food on the plate 12 is desired by the consumer, he positions the analyzer in appropriate position above the plate, as shown in FIG. 1. Thereupon, he presses the scan button 22, which starts the analytical process. The body of analyzer 10 has first and second light sources 24 and 26. Between them is lens 28. When the scan button is actuated, the lamps 24 and 26 are sequentially triggered; for example, 1/15th of a second apart, so that two images are captured.

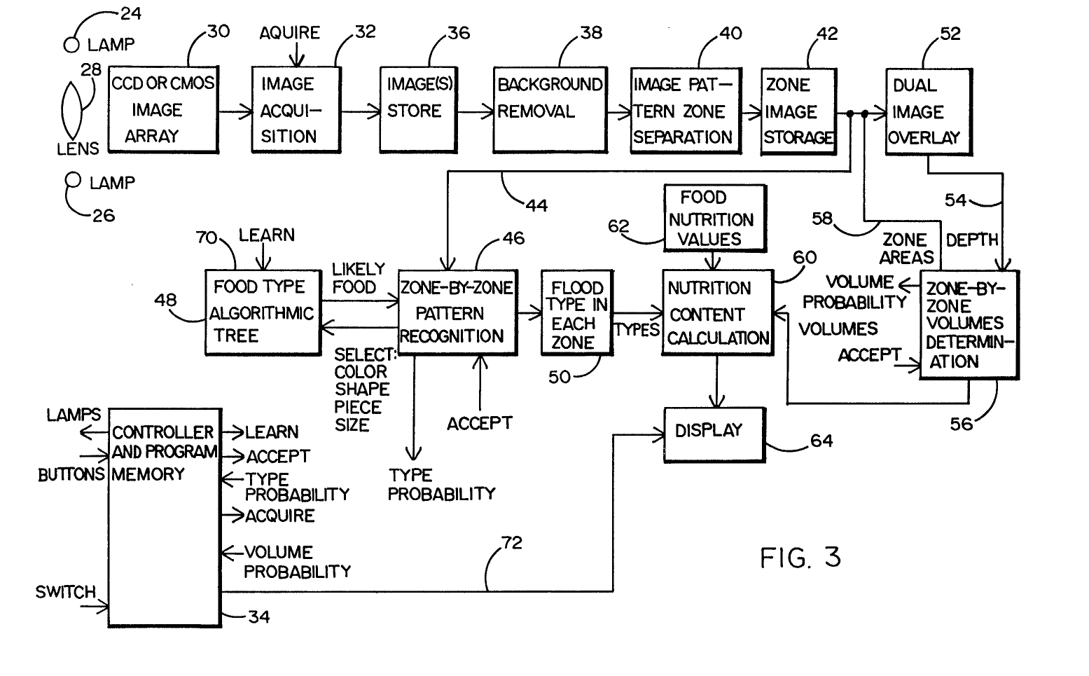

Referring to FIG. 3, behind the lens 28 is image array 30, which converts the optical image into a data string. The two images are of the same subject matter, but are illuminated from different angles so that the shadows show 3-dimensional characteristics. The first and second images are sequentially captured through image acquisition 32, which creates a block of data corresponding to the color pixel array of the camera upon command by the “acquire” signal from the controller and program memory 34.

After processing, the first and second images are stored in image memory 36. The images continue to be sequentially processed through the background removal in processor 38 and through the separator 40, which separates the various food zones on the plate. The separate zones of food are stored in zone image storage 42. From the zone image storage, the same information is processed on two parallel paths.

Since the food type identification does not need two images, only the first image information is transmitted over image path 44 to the pattern recognition system 46. The pattern recognition system 46 operates on a zone-after-zone basis to sequentially determine the nature or character of the food in each zone. Considering the food in the first zone, the pattern recognition system 46 analyzes on the basis of color, pattern, shape and size of the food in that zone. It utilizes information from a food type algorithmic tree 48. When a likely food type is determined, reference is made to food type data stored in memory 50. The data for each food type is generally available, such as found in “Nutritive Value of American Foods,” by Catherine F. Adams, U.S. Agricultural Research Service Agriculture Handbook No. 456, U.S. Government Printing Office, 1975. In connection with the zone-by-zone pattern recognition system 46, this system is connected to the controller 34. After the system 46 is active, it delivers the type probability to the memory 34 and, once received, this information is accepted and the acceptance signal goes back to the pattern recognition system 46.

In order for the logic system to find a reference or a “default” set of data, it is desirable to provide a test device 51, which can be placed on the plate 12 beside the food. The test device has a known color, size, shape and height to provide basic settings for the logic in the analyzer. In the example, the test device 51 is a device which is hexagonal in two dimensions and which has a known height as well as known size and color. The logic system looks for this distinctive test device 51 as a know reference.

There are two images for each food zone. These images are illuminated from different angles so that the height of the food is represented by different shadows. These two images are overlaid in dual image overlay 52 so that a food depth signal is transmitted by line 54 to zone-by-zone volume calculator 56. This calculation requires the zone food area which is delivered by line 58 to the volume calculator.

The food volume and food type in each volume are delivered to nutrient content calculator 60. The nutrient content calculator also has a memory 62 from which it receives information as to the nutritional value of the food type. The nutrient content is displayed to the user on display 64.

Rather than a simple display of total fats or total calories, the controller 34 can scroll through the various conclusions reached by the logic system. Different persons have different requirements as to knowing the nature of their dietary intake. This scrolling data can advise the user the weight of each of the food types on the plate, as well as calories for each type. In addition, protein, carbohydrate, fat, fiber, cholesterol, vitamins and minerals can be individually displayed to the user by scrolling through the conclusion reached by the logic system. Scroll buttons 66 and 68 are inputs to the controller 34 and cause scrolling through the information used to reach the conclusions. For example, the food types can be displayed so that the user can be sure that the system determines the proper food type. If the system selected the wrong food type, a correction could be made by scrolling through a list of possible food types and substituting that into the analysis system. This is the input 70 to the food type algorithmic tree, which corrects the tree for the next analysis.

Line 72 sends the scrolling signals to the display to overcome the normal display of the nutritional value of the food on the plate. The image is processed to identify the different food zones on the plate, the volume of the food within each food zone, and the food type both by color and pattern in each food zone. Once the food type and food volume are determined for each zone, the nutritional totals are calculated by using a permanent data base in the food nutritional values memory 62.

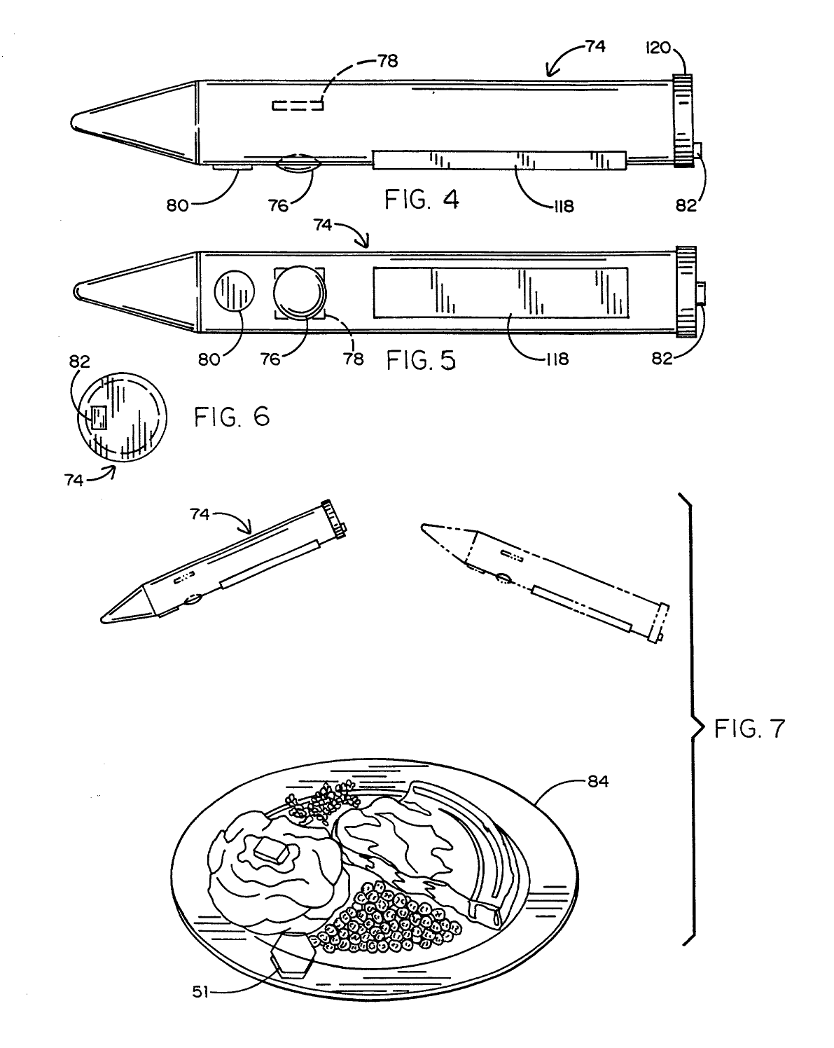

The second preferred embodiment of the personal food analyzer of this invention is generally indicated at 74 in FIGS. 4, 5, 6 and 7. The personal food analyzer 74 obtains the necessary comparative images by using one light source and lens and moving the analyzer between taking the first and second images. Food analyzer 74 has a lens 76 with an image array 78 behind the lens. Lamp 80 is directed toward the scene to be acquired by the image sensor array 78. Lamp 80 is illuminated by pressing on switch 82.

FIG. 7 shows the manner in which the food information is acquired by the food analyzer. The analyzer 74 is positioned in an upper left first position with its lens directed toward the dinner plate 84, which carries the same food thereon as the dinner plate 12. The analyzer 74 is positioned off-axis from the center of the plate, but the lens is directed toward the center of the plate. The user knows the optimum distance for acquiring that image and attempts to place the analyzer 74 at the correct distance. When he is satisfied that his position is near optimum, he actuates the switch 82 and acquires a first image. The image data passes through image acquisition processor 86 and is stored in image one memory 88. The user then moves the analyzer 74 to the second, phantom line position at the upper right of the plate 84. He attempts to place it at the same angle and the same distance. When he is satisfied, he again actuates the switch 82, and the second image is acquired through processor 86 and is stored in image two memory 90.

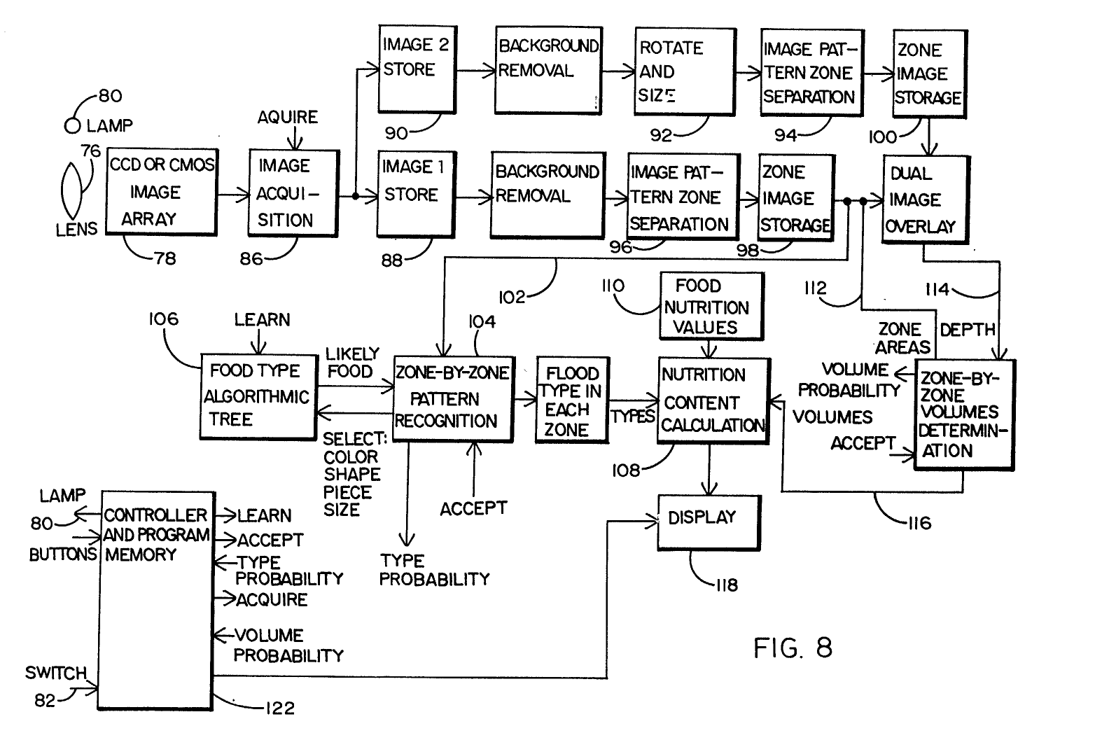

As seen in FIG. 8, the data corresponding to both the first and second image are processed to remove the background. After the image storage, both the first and second image data go through background removal, as previously described. Since the second image may have been taken at a different distance and at a different angle of the analyzer 74, in order to compare the two images, the second image data passes through a rotation and sizing processor 92. Processor 94 and its companion processor 96 separate the image into individual food zones, and the first and second separate food zone images are stored in memories 98 and 100. From this point, the data is processed in the same manner as is shown in FIG. 3. The zone image storage is transmitted by line 102 to zone-by-zone pattern recognition processor 104, which analyzes the food by reason of color, shape and size by utilizing an algorithmic tree 106. This algorithmic tree is so connected as to learn by later correcting the identification, if necessary. The information as to food type passes to the nutrition calculator. The nutrition calculator also has an input from memory 110 which stores the food nutritional values.

The volume of the food in a particular zone is determined by the area of the food in line 112 and the depth of the food in line 114. The depth is determined by comparing the two images. The volume information for the food in a particular zone is passed through line 116 to the nutrient content calculator 108. The boundaries between food types may, at times, be uncertain. When this happens, the processor will display its values and certainty level and ask for correction or acceptance. The product of the nutrition content calculation is shown on display 118 on the side of the analyzer 74. The display may be scrolled by utilizing the scroll knob 120 on the end of the analyzer 74 controller, which manages the whole data process.

Both the analyzers 10 and 74 provide the user with nutritional intake information in real time. This information includes a summary of all the nutritional values of the food items on the plate, including calories, fat, protein, carbohydrate, fiber, enzyme, minerals, etc. Since the device is hand-held and is self-powered, it can be utilized in any food serving environment. Nutritional data is displayed in text form on the display, and the buttons allow the user to scroll the real data. In addition, the controller may retain memory so that totals or daily averages can be shown over a time period.

The utilization of a white light is preferred because a 3-dimensional color image is captured at a sufficient resolution to be useful. White light is preferred because of its color capability, but if more accurate volume data is necessary, laser lighting can be employed. Should the user disagree with a food type or volume, it can be corrected as described. Such a correction can also influence future analyses by correction of the algorithmic factors. The algorithm is originally supplied with a factory default, and if desired, after correction, the default status can be restored by the user. Also, a port can be provided for reading the algorithm or to improve it or to transfer accumulated data to a computer for plotting or long-term totals.

This invention has been described in its presently preferred best modes and it is clear that it is susceptible to numerous modifications, modes and embodiments within the ability of those skilled in the art and without the exercise of the inventive faculty. Accordingly, the scope of this invention is defined by the scope of the following claims.

What is claimed is:

1. A personal food analyzer comprising:
an image acquisition system for acquiring the image of a plate of food and for producing a nutritional data string corresponding to the image of the plate of food;
a processor connected to receive the data string for determining both the food type on the plate and the food volume on the plate;
a nutrition calculator having stored food nutrition values, said processor being connected to said nutrition calculator so that each type of food and its volume is multiplied by the food nutrition value of that particular food so that the nutrition content is calculated; and
a display connected to said nutrition calculator for informing the user of the nutritional content of the food in the image.

2. The personal food analyzer of claim 1 wherein said image acquisition system includes acquiring first and second images of the plate and includes comparison of the images for determination of the volume of the food on the plate.

3. The personal food analyzer of claim 2 wherein said food analyzer has a portable housing and said housing has first and second lamps therein, said first and second lamps being sequentially actuated to produce first and second images which have different shadows due to the relative position of said first and second lamps, to aid in volume calculation.

4. The personal food analyzer of claim 3 wherein said first and second lamps are sequentially lighted at a sufficiently close time interval so that there is no significant motion in that time interval between said food analyzer and the plate.

5. The personal food analyzer of claim 2 wherein the first and second images are sequentially acquired and there is a processor which removes the background and separates the food on the plate into different zones corresponding to different foods and sequentially delivers these images to a food volume processor;
said food volume processor being connected to determine the volume of food in each zone and said food volume processor being connected to said nutrition content calculator.

6. The personal food analyzer of claim 5 wherein said food analyzer has a single lamp and said lamp is illuminated to acquire a first image when said personal food analyzer is in a first position with respect to a plate of food and said lamp is again illuminated to acquire a second image when said personal food analyzer is in a second position with respect to the plate.

7. The personal food analyzer of claim 6 wherein there are first and second image processors and one of said image processors includes a system to rotate and size the image so that said first and second images are comparable and there is a dual image overlay comparator with both of said image processors connected thereto so that said image overlay determines food volume by differences in overlap configuration.

8. The personal food analyzer of claim 5 wherein there is a food recognition processor which analyzes the color, pattern, shape and size of the food in a particular zone to identify the food.

9. The personal food analyzer of claim 8 wherein an output port is provided to allow process algorithms to be downloaded into an external computer to read, analyze and correct algorithms.

10. The personal food analyzer of claim 9 wherein an output port is provided to allow nutritional data to be downloaded into an external computer for plotting or long-term storage.

11. A personal food analyzer comprising:
a body, said body carrying first and second lamps and an image array;
a controller in said analyzer, said controller sequentially lighting said first and second lamps to sequentially acquire first and second images respectively lighted by said first and second lamps;
an image processor to separate the first and second images into separate zones for each food;
a food recognition processor for determining the kind of food in each zone;
a zone volume determination processor for receiving both of said first and second images so that image comparison permits zone volume determination, said zone volume determination processor being connected to a nutrient content calculator, said food type recognition processor being connected to said nutrition content calculator so that the nutrition content of each zone can be calculated; and
an output device for indicating to the user the nutritional content of the food.

12. The personal food analyzer of claim 11 wherein there is a food nutrition value memory connected to said nutrient content calculator.

13. The personal food analyzer of claim 11 wherein there is a food-type algorithmic calculator connected to said food-type recognition processor so that food type is recognized by algorithmic logic.

14. The personal food analyzer of claim 13 wherein said food-type algorithmic processor has an input so that should the food type algorithmic processor incorrectly identify a food, said input can be actuated to correct the food-type information.

15. The personal food analyzer of claim 11 wherein said housing has an image lens and an image array, said image lens and said image array defining an axis which is to be directed toward the plate of food when analysis is desired and said first and second lamps are positioned on substantially opposite sides of said axis and directed toward the plate of food so that the sequential lighting of said first lamp and said second lamp produce different images by virtue of different illumination angle.

16. A personal food analyzer comprising:
a body;
an image-sensing array within said body, a lens positioned with respect to said array, said array and said lens defining an image axis, a lamp, a power source for said lamp and a switch to actuate said lamp, said lamp illuminating a plate of food lying on said axis;
a first image processing system for processing an image detected by said array when said food analyzer is held in a first position with respect to a plate of food and said lamp is first lighted to make the food on the plate visible for the first image, a first image storage and processing system for producing zone images of individual food zones;
a second image storage and processing system for storing a second image of the plate of food when said analyzer is held in a second position with respect to the plate and the lamp is lighted in the second position;
a second image storage and processing system for rotating and sizing the second image so it corresponds in rotational position and size to the first image and for separating the second image into food zones;
an image comparator, said first image processor and said second image processor being connected to said comparator so that said comparator can determine the volume of food in each zone;
a food recognition processor, at least one of said zone image processors being connected to said food recognition system so that the type of food in each zone is identified;
a nutrition content calculator connected to both said food-type recognition system and to said zone volume determination processor so that a total nutrition count of the zones on the plate can be calculated.

17. The personal food analyzer of claim 16 wherein there is an information output device connected to said nutrition content calculator so that said output device can advise the user as to nutrition content.

18. The personal food analyzer of claim 17 wherein said information output is a visual display.

19. The personal food analyzer of claim 16 wherein there is a food-type algorithmic processor connected to said zone food pattern processor to select the food type by color, shape and size.

20. The personal food analyzer of claim 16 further including a controller for controlling said processors.

21. The personal food analyzer of claim 16 wherein there is a controller and said controller has a manual input thereto, said controller being connected to said algorithmic processor to correct and update said algorithmic processor.

22. The personal food analyzer of claim 21 wherein there is an output accessible to the user connected to receive and display the output of said nutritional content calculator for each individual food zone and the total thereof.

23. The personal food analyzer of claim 21 wherein said nutritional content calculator has an output to inform the user of the total nutritional value of the food on the plate.

24. The personal food analyzer of claim 16 further including a reference piece for placement on a plate of food, said reference piece being a reference standard for said food analyzer said reference piece having a known characteristic known by said food recognition processor.
